(19) United States
(12) Patent Application Publication
(10) Pub. No.: US 2013/0051072 A1
(43) Pub. Date: Feb. 28, 2013

(54) LIGHT SOURCE DEVICE

(71) Applicants: Yu-Chuan Wen, Hsin-Chu (TW); Chen-Kun Liu, Hsin-Chu (TW)

(72) Inventors: Yu-Chuan Wen, Hsin-Chu (TW); Chen-Kun Liu, Hsin-Chu (TW)

(73) Assignee: CORETRONIC CORPORATION, Hsin-Chu (TW)

(21) Appl. No.: 13/594,890

(22) Filed: Aug. 27, 2012

(30) Foreign Application Priority Data
Aug. 30, 2011 (TW) 100131086

(51) Int. Cl. F21V 8/00

(52) U.S. Cl. 362/611

(57) ABSTRACT

A light source device includes a first light-emitting element providing illumination beams, a light guide plate (LGP) divided into light-transmissive regions, an optical thin film, and microstructures. The LGP has a first surface, a second surface opposite to the first surface, and a first light-incident surface connecting the first and second surfaces. The first light-emitting element is beside the first light-incident surface. The illumination beams are capable of entering the LGP through the first light-incident surface. The optical thin film is on the second surface of the LGP. The optical thin film has different thicknesses corresponding to at least two of the light-transmissive regions. The microstructures are on the optical thin film. When the illumination beams pass through the light-transmissive regions corresponding to the different thicknesses of the optical thin film and leave the LGP through the first surface, the illumination beams are converted into color beams with different wavelengths.

### CROSS-REFERENCE TO RELATED APPLICATION

This application claims the priority benefit of Taiwan application serial no. 100131086, filed on Aug. 30, 2011. The entirety of the above-mentioned patent application is hereby incorporated by reference herein and made a part of this specification.

### BACKGROUND OF THE INVENTION

1. Field of the Invention

The invention relates to an optical device. More particularly, the invention relates to a light source device.

2. Description of Related Art

The most common light source devices include a backlight module, and the backlight module usually includes a light guide plate (LGP). Generally, the LGP serves to guide an ongoing direction of light, to increase luminance of a panel, and to ensure the uniformity of the luminance of the panel. Thereby, the point light source or the linear light source in the backlight module can be transformed into the planar light source, and the planar light source can serve as a light source to a liquid crystal display (LCD) panel.

In more detail, when the light beam enters the LGP, the light beam can continuously undergo total reflection and can thus be emitted from the LGP. Alternatively, microstructures on the surface of the LGP may destroy the total reflection of the light beam and result in deflection of light path, such that the light beam is emitted from the LGP. The microstructures can also correct the direction of the light. For instance, Taiwan R.O.C. Patent No. 1273293 and U.S. Patent Publication No. 20100226147 both disclose an LGP having microstructures. U.S. Pat. No. 7,108,415 discloses a method of fabricating an LGP. U.S. Pat. No. 3,610,727 discloses a structure associated with an LGP.

However, according to the related art, the light generated by a light source is often white light that is composed of different color beams. The different color beams in the LGP may interfere with one another. Hence, the color beams are emitted from the LGP which results in partial color shift in the LGP, thus leading to chrominance of the subsequently displayed images of the LCD. Moreover, since the backlight module is a finished product when one sees the chrominance of the images of the LCD, the chrominance issue caused by the interference of different color beams can no longer be resolved.

### SUMMARY OF THE INVENTION

The invention is directed to a light source device that may resolve the chrominance issue.

Other advantages of the invention can be further illustrated by the technical features broadly embodied and described as follows.

In order to achieve one or a part of or all of the above advantages or other advantages, an embodiment of the invention provides a light source device. The light source device includes a first light-emitting element, a light guide plate (LGP), an optical thin film, and a plurality of microstructures. The first light-emitting element is capable of providing illumination beams. The LGP is divided into a plurality of light-transmissive regions. Besides, the LGP has a first surface, a second surface opposite to the first surface, and a first light-incident surface connecting the first surface and second surface. The first light-emitting element is configured beside the first light-incident surface of the LGP, and the illumination beams are capable of entering the LGP through the first light-incident surface. The optical thin film is configured on the second surface of the LGP, and the optical thin film has different thicknesses corresponding to at least two of the light-transmissive regions. The microstructures are configured on the optical thin film. When the illumination beams pass through the light-transmissive regions corresponding to the different thicknesses of the optical thin film and leave the light guide plate through the first surface of the LGP, the illumination beams are converted into a plurality of color beams with different wavelengths.

In one embodiment of the invention, the greater the thickness of the optical thin film is, the shorter a wavelength of the corresponding color beam is.

In one embodiment of the invention, the thickness of the optical thin film adjacent to the first light-emitting element is less than the thickness of the optical thin film away from the first light-emitting element.

In one embodiment of the invention, the thickness of the optical thin film is greater than or equal to 150 nm and is less than or equal to 1500 nm.

In one embodiment of the invention, a refractive index of the optical thin film is greater than or equal to 1.45 and is less than or equal to 1.55.

In one embodiment of the invention, a material of the optical thin film is a resin.

In one embodiment of the invention, a refractive index of the light guide plate is 1.49.

In one embodiment of the invention, the light source device further comprises at least one optical film located on the first surface of the light guide plate.

In one embodiment of the invention, the light source device further comprises a second light-emitting element. The light guide plate further has a second light-incident surface opposite to the first light-incident surface, and the second light-emitting element is configured beside the second light-incident surface.

In one embodiment of the invention, the thickness of the optical thin film adjacent to the first light-emitting element and the second light-emitting element is less than the thickness of the optical film away from the first light-emitting element and the second light-emitting element.

Based on the above, the embodiments of the invention may achieve at least one of the following advantages or effects. According to the embodiments of the invention, the optical thin film with different thicknesses is configured on the LGP, so as to reduce the partial color shift of the LGP caused by the interference of different color beams (constituting the white light according to the related art) in the LGP. Additionally, the optical thin film may compensate the surface defects of the LGP, so as to reduce bright spots.

Other objectives, features and advantages of the invention will be further understood from the further technological features disclosed by the embodiments of the invention wherein there are shown and described embodiments of this invention, simply by way of illustration of modes best suited to carry out the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating a light source device according to a first embodiment of the invention.

FIG. 2 illustrates a method of fabricating a light guide device according to another embodiment.

FIG. 3 is a schematic view illustrating a light source device according to a second embodiment of the invention.

### DESCRIPTION OF EMBODIMENTS

In the following detailed description of the embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

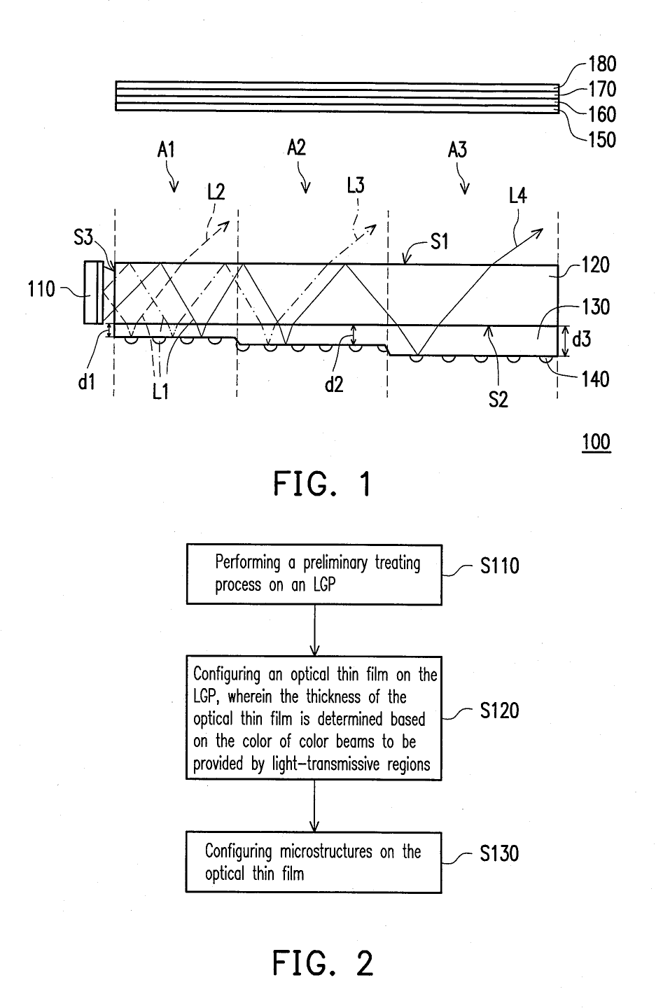

FIG. 1 is a schematic view illustrating a light source device according to a first embodiment of the invention. With reference to FIG. 1, the light source device 100 of this embodiment includes a light-emitting element 110, a light guide plate (LGP) 120, an optical thin film 130, and a plurality of microstructures 140. The light-emitting element 110 is capable of providing illumination beams L1. In this embodiment, the light-emitting element 110 is a light-emitting diode (LED), for instance, and the illumination beams L1 are white light, for instance. Here, the white light is composed of a plurality of different color beams.

As shown in FIG. 1, the light-emitting element 110 is located beside the LGP 120, and the LGP 120 is divided into a plurality of light-transmissive regions A1˜A3 (three light-transmissive regions A1˜A3 are shown in the drawings for example, which should not be construed as a limitation to the invention). The LGP 120 has a surface S1, a surface S2, and a light-incident surface S3. The surface S2 is opposite to the surface S1, and the light-incident surface S3 connects the surfaces S1 and S2. The illumination beams L1 enter the LGP 120 through the light-incident surface S3 and leave the LGP 120 through the surface S1. In this embodiment, a refractive index of the LGP 120 is approximately 1.49, which should however not be construed as a limitation to the invention.

The optical thin film 130 is configured on the surface S2, and the optical thin film 130 has different thicknesses corresponding to at least two of the light-transmissive regions A1˜A3. For instance, the optical thin film 130 has a thickness d1 and a thickness d2 corresponding to the light-transmissive regions A1 and A2 respectively. The microstructures 140 are located on the optical thin film 130. Here, the microstructures 140 may destroy the total reflection of the illumination beams L1 in the LGP 120, such that the illumination beams L1 are deflected and then emitted from the LGP 120. In this embodiment, the microstructures 140 are formed on the surface S2 by ink jet, for instance, and the microstructures 140 are protrusions, for instance. However, the invention is not limited thereto.

In this embodiment, note that the optical thin film 130 has different thicknesses d1 and d2 corresponding to the light-transmissive regions A1 and A2 respectively. Hence, when the illumination beams L1 pass through the light-transmissive regions A1 and A2 corresponding to the different thicknesses d1 and d2 of the optical thin film 130 and leave the LGP 120 through the surface S1, the illumination beams L1 are converted into color beams L2 and L3 separately having different wavelengths. When the color beams L2 and L3 are visible beams, the larger the thicknesses d1 and d2 of the optical thin film 130 are, the shorter wavelengths of the corresponding color beams L2 and L3 are. Therefore, based on the color of the color beams L2 and L3 generated by the light-transmissive regions A1 and A2, a designer may adjust individual thickness of the optical thin film 130 corresponding to the light-transmissive regions A1 and A2. By contrast, when the color beams are invisible beams, the correlation between the thickness of the optical thin film and the wavelength of the color beams may be different from those described above, and therefore the way to adjust the thickness of the optical thin film is correspondingly changed.

For instance, if the color beam L2 generated by the light-transmissive region A1 is expected to be a yellow-green light having a wavelength of 600 nm, the thickness d1 of the optical thin film 130 in the light-transmissive region A1 may be adjusted to be greater than or equal to 275 nm and less than or equal to 325 nm. Nonetheless, the invention is not limited thereto. If the color beam L3 generated by the light-transmissive region A2 is expected to be a blue-green light having a wavelength of 500 nm, the thickness d2 of the optical thin film 130 in the light-transmissive region A2 may be adjusted to be greater than or equal to 725 nm and less than or equal to 800 nm. Similarly, the invention is not limited thereto.

In this embodiment, the thickness d3 of the optical thin film 130 in the light-transmissive region A3 is different from both the thickness d1 and the thickness d2. Hence, when the illumination beam L1 is transmitted to the light-transmissive region A3 and is emitted from the LGP 120 sequentially through the optical thin film 130 (having the thickness d3) and the light-transmissive region A3, the illumination beam L1 is converted into another color beam L4. According to this embodiment, the color beam L4 corresponding to the light-transmissive region A3 is a blue light having a wavelength of 400 nm, for instance, and the thickness d3 of the optical thin film 130 in the light-transmissive region A3 is greater than or equal to 1020 nm and less than or equal to 1220 nm. However, the invention is not limited thereto.

In view of the above, the light-transmissive regions A1˜A3 are allowed to provide different color beams L2˜L4 by adjusting the thicknesses d1˜d3 of the optical thin film 130 corresponding to the light-transmissive regions A1˜A3. Therefore, the light source device 100 of this embodiment may compensate the color chrominance caused by the interference of different color beams (constituting the white light according to the related art) in the LGP. In this embodiment, the color beams L2˜L4 are visible light. Besides, the greater the thicknesses d1˜d3 of the optical thin film 130, the shorter the wavelengths of the corresponding color beams L2˜L4. Hence, the thicknesses d1˜d3 of the optical thin film 130 corresponding to the light-transmissive regions A1˜A3 may be adjusted based on the expected color of the color beams L2˜L4 to be generated by the light-transmissive regions A1˜A3, and thereby the color of the displayed images may be adjusted. Namely, according to this embodiment, the display in which the light source device 100 of this embodiment serves as a backlight module may compensate the conventional color shift of the displayed images of LCD. Moreover, the optical thin film 130 located on the LGP 120 and having different thicknesses may compensate the surface defects of the LGP 120, so as to reduce bright spots.

As indicated in FIG. 1, the thickness of the optical thin film 130 adjacent to the light-emitting element 110 is less than the thickness of the optical thin film 130 away from the light-emitting element 110 according to an embodiment of the invention. Here, the thickness of the optical thin film 130 is greater than or equal to 150 nm and less than or equal to 1500 nm, for instance. In this embodiment, the refractive index of the optical thin film 130 is greater than or equal to 1.45 and less than or equal to 1.55, and the material of the optical thin film 130 may be resin. When the refractive index of the LGP 120 is 1.49, and the refractive index of the optical thin film 130 is greater than 1.55, the haze value of the LGP 120 is excessively high. On the contrary, when the refractive index of the LGP 120 is 1.49, and the refractive index of the optical thin film 130 is less than 1.45, the optical thin film 130 is not conducive to alleviation of the color shift in partial regions of the LGP 120. Therefore, as described above, when the refractive index of the LGP 120 is 1.49, the refractive index of the optical thin film 130 preferably ranges from 1.45 to 1.55. However, the invention is not limited thereto. When the refractive index of the LGP 120 is changed, also the range of the refractive index of the optical thin film 130 is correspondingly changed.

With reference to FIG. 1, the light source device 100 of this embodiment further includes at least one optical film 150, and the optical film 150 is a lower diffuser, for instance. The light source device 100 may further include optical films 160, 170, and 180 which are respectively a lower prism, an upper prism, and an upper diffuser, for instance. The optical films 150, 160, 170, and 180 may increase uniformity of the brightness of the light source device 100.

From another perspective, a method of fabricating a light guide device is also provided in this embodiment. FIG. 2 illustrates a method of fabricating a light guide device according to another embodiment. The light guide device may include the LGP 120, the optical thin film 130, and the microstructures 140 shown in FIG. 1. The method of fabricating the light guide device includes following steps. With reference to FIG. 1 and FIG. 2, a preliminary treating process is performed on an LGP (step S110). For instance, a dust-removal step or a smoothing step is performed on the LGP. The LGP applied in the step S110 is the LGP 120 depicted in FIG. 1, for instance.

Then, an optical thin film is configured on the LGP, and the thickness of the optical thin film is determined based on the color of color beams to be provided by light-transmissive regions (step S120). The optical thin film, the light-transmissive regions, and the color beams in the step S120 are respectively the optical thin film 130, the light-transmissive regions A1˜A3, and the color beams L2˜L4 depicted in FIG. 1, for instance. Next, microstructures are configured on the optical thin film (step S130). The microstructures discussed in the step S130 are the microstructures 140 depicted in FIG. 1, for instance. So far, the light guide device is completely formed.

### Second Embodiment

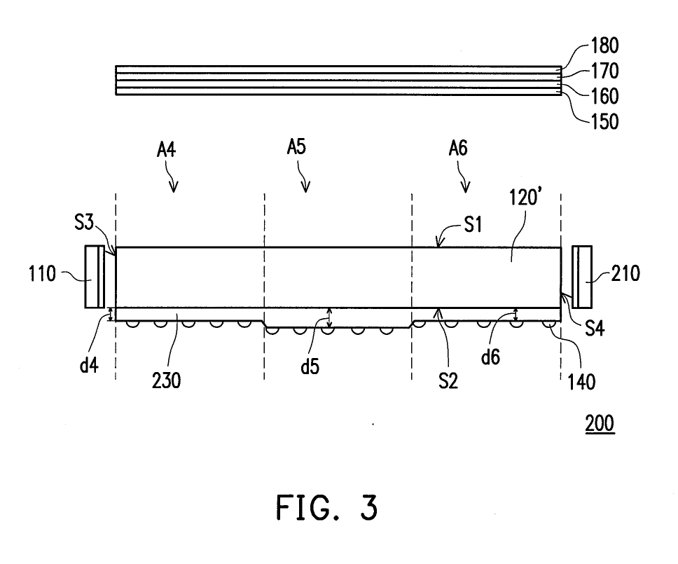

FIG. 3 is a schematic view illustrating a light source device according to a second embodiment of the invention. As indicated in FIG. 3, the light source device 200 is similar to the light source device 100 illustrated in FIG. 1, while the main difference between the light source devices 200 and 100 lies in that the light source device 200 further includes a light-emitting element 210, and the LGP 120′ further has a light-incident surface S4 opposite to the light-incident surface S3. The light-emitting element 210 is located beside the light-incident surface S4. In this embodiment, the light-emitting element 210 is a white LED, for instance.

The thickness of the optical thin film 230 close to the light-emitting elements 110 and 210 is less than the thickness of the optical thin film 230 away from the light-emitting elements 110 and 210. That is to say, the thickness d5 of the optical thin film 230 in the light-transmissive region A5 at the center of the LGP 120′ is greater than the individual thicknesses d4 and d6 of the optical thin film 230 in the light-transmissive regions A4 and A6 at two side portions of the LGP 120′. In this embodiment, the thickness d5 is greater than both the thickness d4 and the thickness d6, and the thicknesses d4 and d6 may be the same or different.

Similarly, the light-transmissive regions A4˜A6 corresponding to the optical thin film 230 with different thicknesses may provide different color beams. Hence, the thicknesses of the optical thin film 230 corresponding to the light-transmissive regions A4˜A6 may be adjusted based on the expected color of the color beams to be generated by the light-transmissive regions A4˜A6, and thereby the color of the displayed images of LCD using the light source device 200 may be adjusted. For instance, the thickness d4 of the optical thin film 230 in the light-transmissive region A4 is 630 nm, and the color beam that leaves the LGP 120′ from the light-transmissive region A4 is a green light having a wavelength of 550 nm. The thickness d5 of the optical thin film 230 in the light-transmissive region A5 is 1350 nm, for instance, and the color beam that leaves the LGP 120′ from the light-transmissive region A5 is a blue light having a wavelength of 380 nm, for instance. The thickness d6 of the optical thin film 230 in the light-transmissive region A6 is 275 nm, for instance, and the color beam that leaves the LGP 120′ from the light-transmissive region A6 is a red light having a wavelength of 623 nm, for instance.

In view of the above, the display in which the light source device 200 of this embodiment serves as a backlight module may compensate the conventional color shift of the displayed images. Moreover, the optical thin film 230 located on the LGP 120′ and having different thicknesses may compensate the surface defects of the LGP 120′, so as to reduce bright spots. Since the light source device 200 of this embodiment has been elaborated in the embodiment shown in FIG. 1 and FIG. 2, no further description is given herein.

In light of the foregoing, the embodiments of the invention may achieve at least one of the following advantages or effects. According to the embodiments of the invention, the optical thin film with different thicknesses is configured on the LGP, so as to compensate the partial color shift of the LGP caused by the interference of different color beams (constituting the white light according to the related art) in the LGP. As such, the LGP described in these embodiments may resolve the chrominance issue of the displayed images. In addition, the optical thin film may compensate the surface defects of the LGP, so as to reduce bright spots. As a result, the display in which the light source device of these embodiments serves as the backlight module may display images to a better extent.

The foregoing description of the exemplary embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Apparently, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A light source device comprising:
a first light-emitting element capable of providing illumination beams;
a light guide plate divided into a plurality of light-transmissive regions, and the light guide plate having:
a first surface;
a second surface opposite to the first surface; and
a first light-incident surface connecting the first surface and the second surface, the first light-emitting element being configured beside the first light-incident surface of the light guide plate, the illumination beams being capable of entering the light guide plate through the first light-incident surface;
an optical thin film configured on the second surface of the light guide plate, wherein the optical thin film has different thicknesses corresponding to at least two of the light-transmissive regions; and
a plurality of microstructures configured on the optical thin film;
when the illumination beams pass through the different light-transmissive regions corresponding to the different thicknesses of the optical thin film and leave the light guide plate through the first surface of the light guide plate, the illumination beams are converted into a plurality of color beams with different wavelengths.

2. The light source device as recited in claim 1, wherein the greater the thickness of the optical thin film, the shorter a wavelength of the corresponding color beam.

3. The light source device as recited in claim 1, wherein the thickness of the optical thin film adjacent to the first light-emitting element is less than the thickness of the optical thin film away from the first light-emitting element.

4. The light source device as recited in claim 1, wherein the thickness of the optical thin film is greater than or equal to 150 nm and is less than or equal to 1500 nm.

5. The light source device as recited in claim 1, wherein a refractive index of the optical thin film is greater than or equal to 1.45 and is less than or equal to 1.55.

6. The light source device as recited in claim 5, wherein a material of the optical thin film is a resin.

7. The light source device as recited in claim 5, wherein a refractive index of the light guide plate is 1.49.

8. The light source device as recited in claim 1, further comprising at least one optical film located on the first surface of the light guide plate.

9. The light source device as recited in claim 1, further comprising a second light-emitting element, the light guide plate further having a second light-incident surface opposite to the first light-incident surface, the second light-emitting element being configured beside the second light-incident surface.

10. The light source device as recited in claim 9, wherein the thickness of the optical thin film adjacent to the first light-emitting element and the second light-emitting element is less than the thickness of the optical film away from the first light-emitting element and the second light-emitting element.
